(19) United States
(12) Patent Application Publication
(10) Pub. No.: US 2012/0012607 A1
(43) Pub. Date: Jan. 19, 2012

(54) GUM DISPENSER

(76) Inventors: James J. Kopco, Mentor-on-the-Lake, OH (US); Joseph L. Walton, Massillon, OH (US)

(21) Appl. No.: 13/177,205

(22) Filed: Jul. 6, 2011

Related U.S. Application Data
(60) Provisional application No. 61/365,130, filed on Jul. 16, 2010.

(51) Int. Cl. B65D 83/00; B65G 59/00

(52) U.S. Cl. 221/155; 221/223

(57) ABSTRACT

A product dispenser particularly suited for relatively thin products such as packs of gum incorporates a housing with a front wall that pivots downwardly to allow the interior to be stocked with the product. The front wall includes a slot opening and a tray extends through the slot opening to dispense product. The handle of the tray is pulled away from the unit causing the tray to push the lowest most product through the slot pushed by a raised rear portion of the tray. The raised rear portion also prevents the next lowest product from falling on the tray when it is in extended position. The tray is then retracted by a spring, and the next lower product drops on the tray and is ready for dispensing.

### RELATED APPLICATION

This application is related to and claims the benefit of U.S. Provisional Patent Application Ser. No. 61/365,130, filed Jul. 16, 2010, the disclosure of which is incorporated herein by reference.

### BACKGROUND OF THE INVENTION

Theft from stores is a common and ongoing problem. One type of thievery involves sweeping in which a thief enters the store, grabs a large number of one item and runs out of the store. One such item that is the subject of this type of theft is multiple packs of gum. These packs of gum, which include 4 or 5 individual packs of gum, can be easily resold.

To prevent sweeping, stores have switched to dispensers which allow the customer to remove only a single item at a time. Such a dispenser must be inexpensive. Further, the dispenser must be user friendly, or it will deter an honest customer from selecting the item. Finally, the device must be effective.

### SUMMARY OF THE INVENTION

The present invention is premised on the realization that a single item dispenser for generally rectangular thin items such as multiple packs of chewing gum will effectively deter theft.

Such a device includes a case with a locking opening and a tray device that allows one pack of the product to be dispensed at a time. The tray slides back and forth within the dispenser moving the product through a slot opening in the dispenser. The products are stacked inside the dispenser, and the tray pushes one item at a time. It then returns automatically, and allows the bottom most product to be subsequently dispensed.

Preferably, the device makes a sound as the tray moves in and out. In particular, a simple clicking device can be employed. This will alert a clerk that multiple items are being withdrawn in a very short period of time.

The objects and advantages of the present invention will be further appreciated in light of the following detailed description and drawings in which:

### BRIEF DESCRIPTION OF THE DRAWING

FIG. 1 is a perspective view of the present invention;

FIG. 2 is an enlarged perspective view of the present invention broken away;

FIG. 3 is a rear view of the present invention;

FIG. 4 is an enlarged rear view broken away;

FIG. 5 is a perspective view of the tray, which is part of the present invention;

FIG. 6 is a cross sectional side view with the tray in a retracted position;

FIG. 7 is a view similar to FIG. 6 with the tray in a partially pulled out position; and

FIG. 8 is a perspective view of an alternative embodiment of the tray, which is part of the present invention.

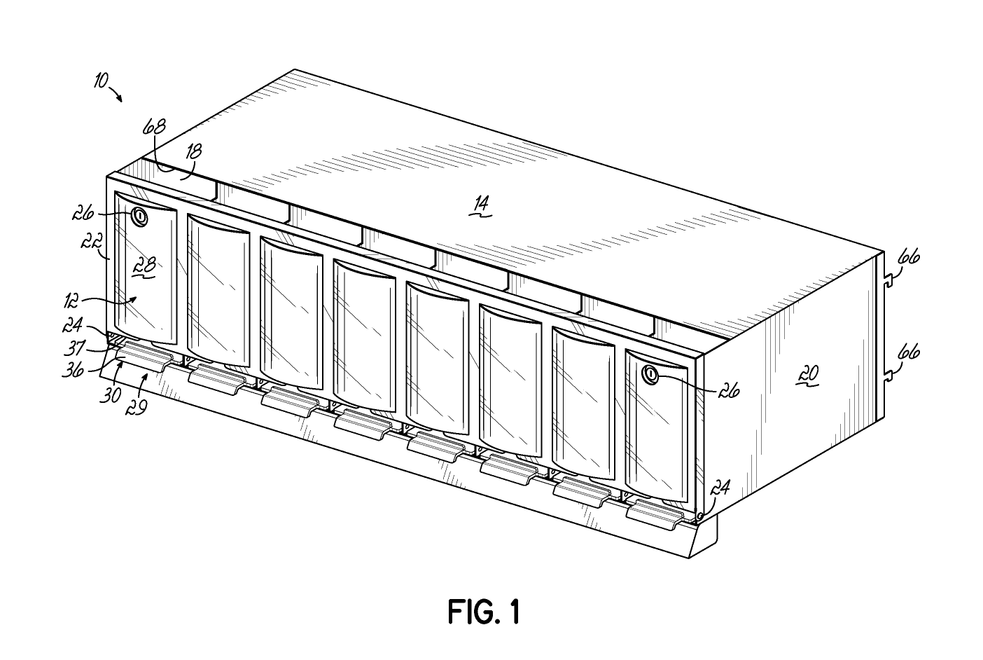

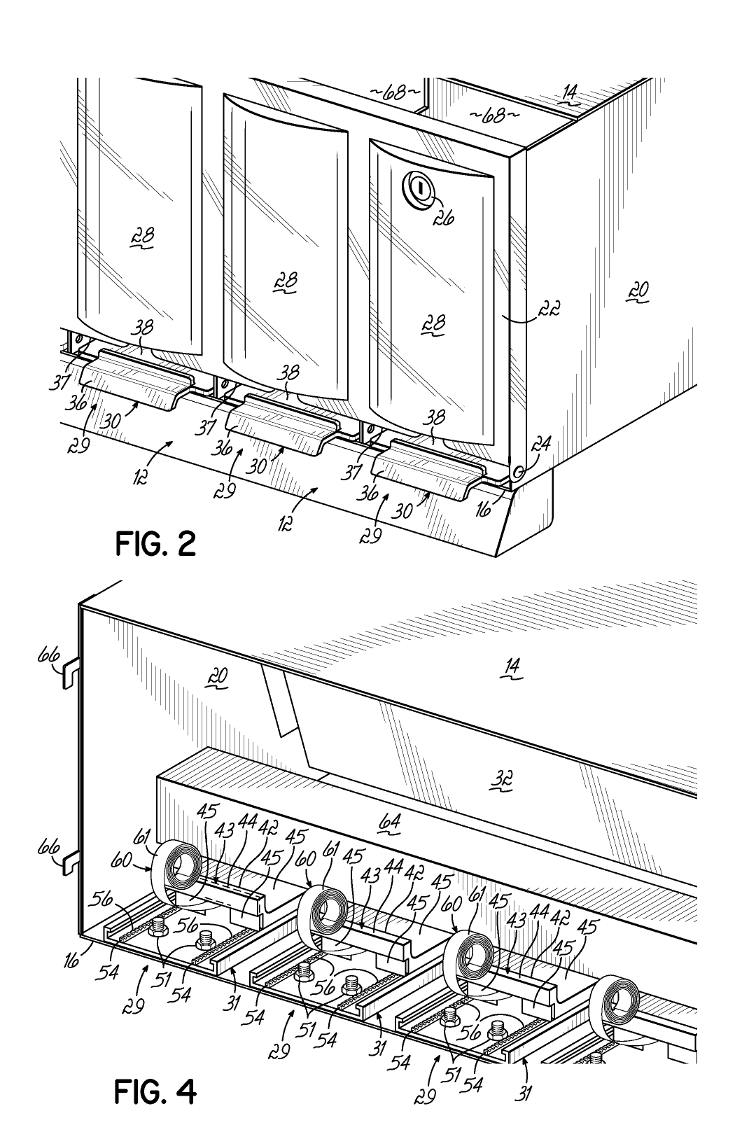

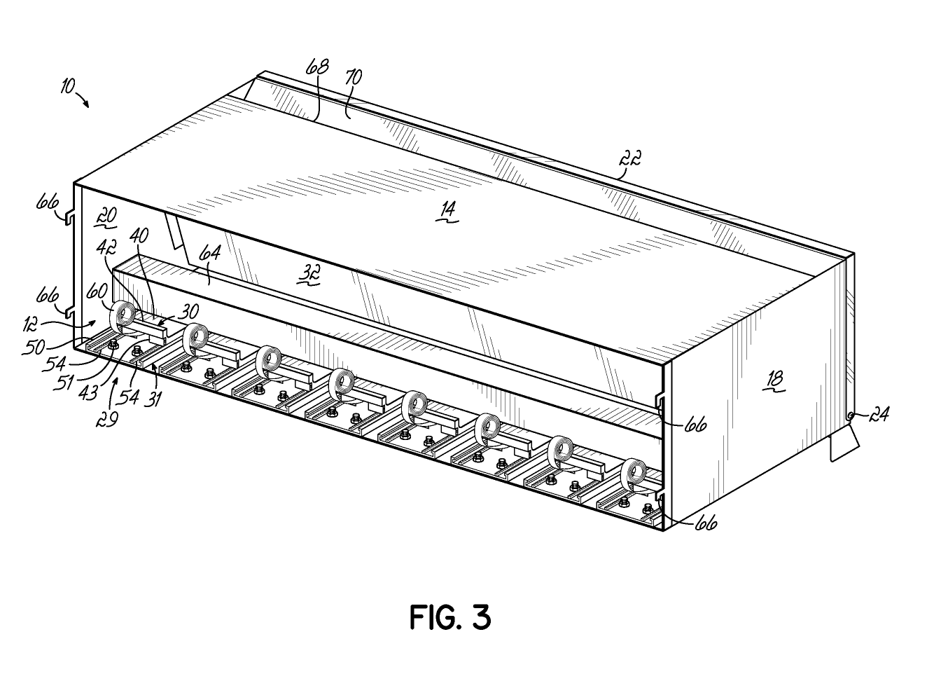

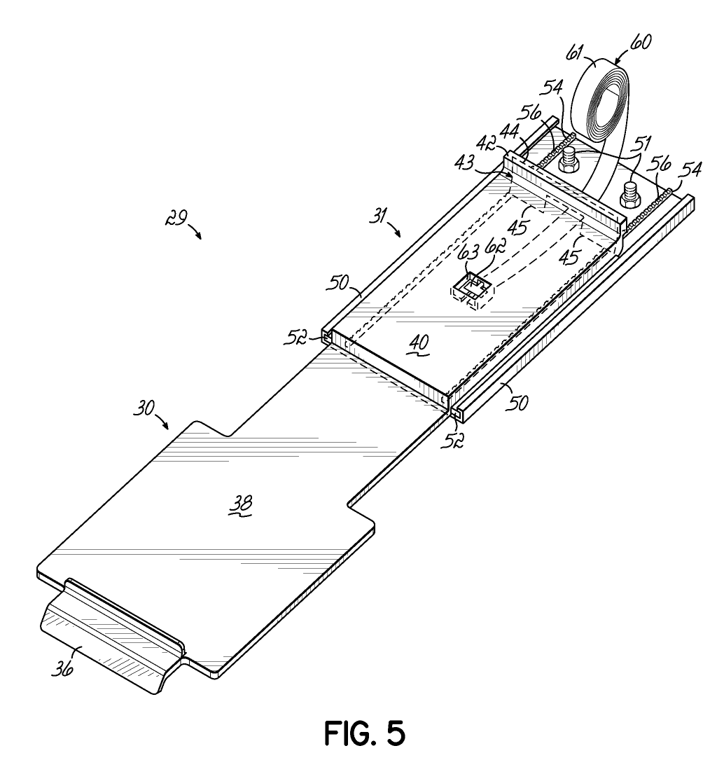

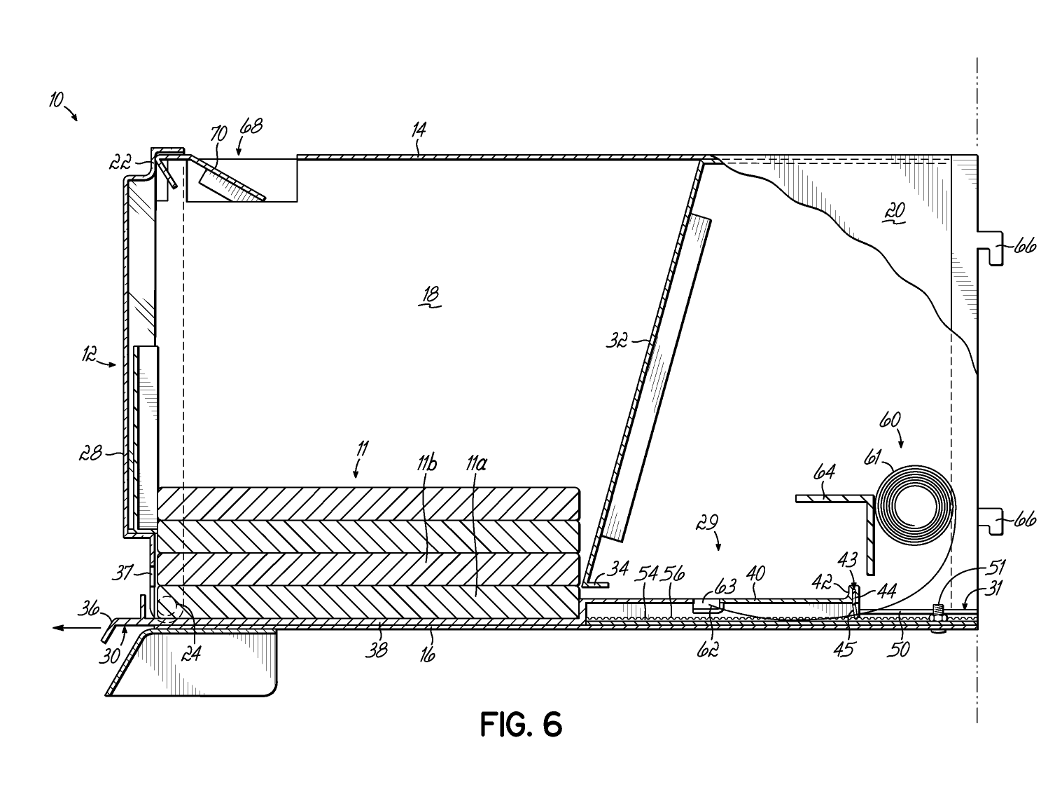

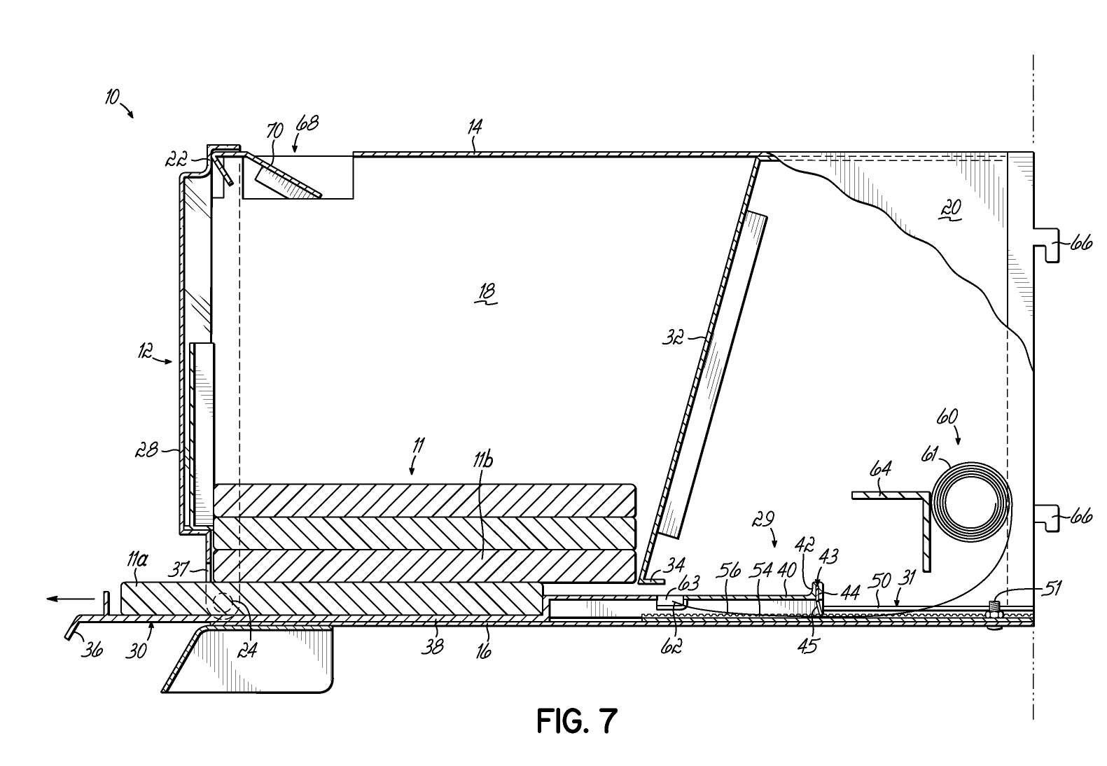

### DETAILED DESCRIPTION

The present invention is a dispensing unit 10 adapted to dispense thin rectangular products such as packs that contain multiple packs of chewing gum 11. As shown, the dispensing unit 10 has multiple bays 12. However, the unit can be a single bay (not shown) or two or more bays. Each bay 12 includes a top wall 14, a bottom wall 16, a first side wall 18 and an opposed second side wall 20. With multiple bay units these sidewalls act as dividers between adjacent bays. The unit further includes a front wall 22.

The front wall 22 is fixed to the two side walls at hinges 24 (one shown). A lock 26 maintains the front wall 22 in an upright position and allows access to the inside of the bay 12 only by authorized personnel. The front wall 22 further includes a display area 28 which allows graphics or the product to be displayed and viewed by potential purchasers.

Inside the bay 12 is a tray assembly 29 which includes a tray 30 and a base 31. The tray 30 slides beneath a sloped internal wall 32 which has a bottom edge 34 spaced from the bottom wall 16 a distance sufficient to allow movement of tray 30.

Tray 30 further includes a handle 36 which extends forward of front wall 22 through a slot 37 in the front wall. The slot 37 is of a size slightly larger than the thickness of the product 11 being dispensed.

The tray 30 includes a forward flat or lower portion 38 and a rearward raised portion 40. The rear edge of the tray is a raised flange 42 which holds a thin plastic member 43. The plastic member 43 includes a top section 44 and two legs or tabs 45. Flange 42 limits the forward movement of tray 30 when it engages lower edge 34 of wall 32.

The base 31 includes two side channels 50 which receive side edges 52 of the tray 30. The base 31 is fixed to the bottom wall 16 by fasteners or other mechanisms. Bolts 51 are shown. The tray 30 slides relative to the base 31 with the edges 52 sliding within side channels 50. The base 31 further includes axial ridges 54 which include upper serrated edges 56. The tray 30 is urged into the bay 12 by a coil spring 60 which includes a coiled end 61 and an opposite end 62 which is fixed to the tray at point 63. The coil spring 60 runs between the ridges 54. The coil 61 is prevented from moving forwardly by an internal bracket 64 which extends between the first and second side walls 18 and 20. A compression spring or other spring mechanism can also be used.

The back edges of side walls 18 and 20 include mounting hooks 66 designed to fit into openings in vertical channels that are either mounted to a wall or other shelving device. Alternately, the unit 10 can simply rest on a shelf.

In use, multiple packets of gum or other product are positioned in the bay 12 on the flat portion 38 of tray 30 which rests on the bottom wall 16. Access to this area is achieved by opening lock 26, pivoting the front wall 22, and placing the product in the unit. The front wall 22 is closed and the lock 26 turned to the locked position.

An individual can take the bottom most pack of gum 11a by pulling the handle 36 which will cause the tray 30 to slide outwardly. The raised portion 40 of tray 30 pushes the pack of gum 11a through slot 37 so that the purchaser can take one item, but no more than one item. The raised portion 40 also prevents the next pack 11b from lowering if pack 11a is not taken. The tray 30 may have a limited range of motion so that only a portion of the product is exposed when the tray 30 is pulled out. In other words, a section of the flat portion remains in the bay when the tray is fully extended. When the purchaser takes a pack 11a and releases handle 36, the spring 60 will pull the tray 30 rearwardly. Once the raised portion 40 of tray 30 passes through the opening beneath the sloped wall 32, the next adjacent pack of gum 11b will fall onto the flat portion 38 of the tray 30 and is ready to be dispensed.

As the tray 30 moves forwardly and rearwardly, the tabs 45 will run over the serrated edges 56 of ridges 54 making a clicking sound. This will alert the store personnel that someone is accessing the packs of gum. The clicking sound is, of course, exemplary of a noise that can be made. Other structures such as bells, or the like, can be used.

The individual will pull on the tray exposing enough of the product for the customer to grasp. Because the tray is under constant tension, the customer must use two hands, one to pull tray and one to grasp product. This also deters repeated theft.

If an individual decides that they do not want the pack of gum 11, it can be returned into the bay 12 through an opening 68 in top wall 14. This includes a sloped wall 70 that prevents someone with a small hand from reaching inside, and, further, guides the returned pack of gum to its proper location. Further, the slope in sloped wall 32 will further facilitate proper location of the pack of gum.

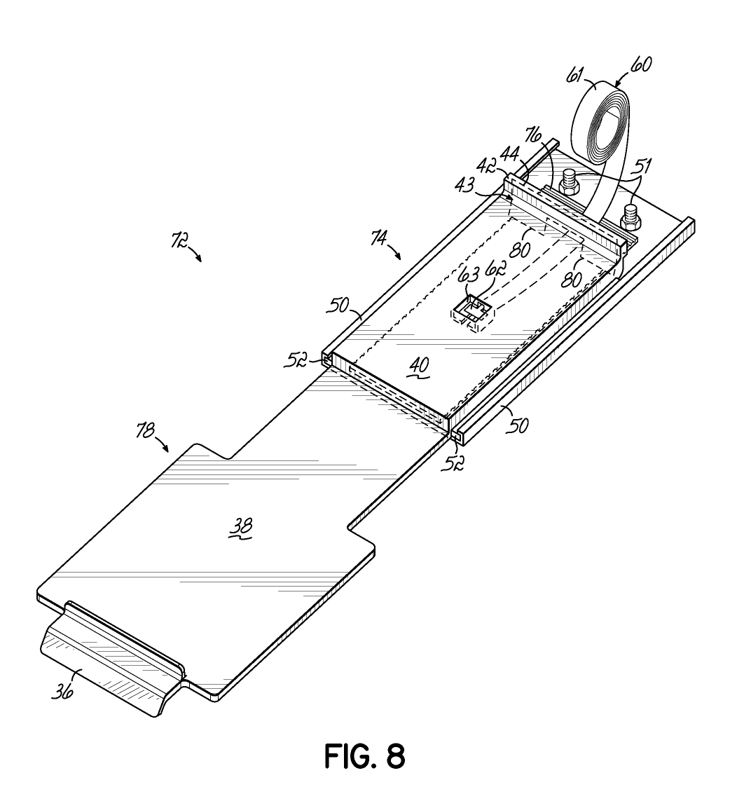

An alternate embodiment of the tray assembly is shown in FIG. 8. In this embodiment 72 the base 74 does not include serrated ridges but includes transverse raised portions 76. The tray 78 is the same as tray 30. Thus, the sound is caused by tabs 80 (shown in phantom) running across raised portions 76.

As indicated, the present invention can be practiced using a variety of different elements. For example, as shown, the front wall simply pivots downwardly hinged at the bottom. This can be hinged at the side or top, or can slide to open. An alternate form of opening from the top wall can also be utilized. In addition, different types of sound generating mechanisms can be used. Any sound mechanism that is activated by the movement of the tray will work in the present invention. In addition, as previously indicated, the unit 10 can be one bay or can be multiple bays depending upon the desires of the customer. The dispenser can be used for a wide variety of similarly shaped products.

This has been a description of the present invention along with the preferred method of practicing the present invention. However, the invention itself should only be defined by the appended claims, WHEREIN WE CLAIM:

What is claimed is:

1. A product dispenser having a housing and a base tray spring biased in said housing, said tray having a front handle, a forward portion and a rearward raised portion;
said tray extended through a lower slot opening in a front wall of said housing with product stacked in said housing and said forward portion of said tray whereby pulling said handle and said tray through said slot opening causes said raised portion to move forward and engage a bottom product, pushing said bottom product through said slot opening and wherein said spring urges said tray back into said housing when said handle is released.

2. The product dispenser claimed in claim 1 wherein said tray has a tab which engages said base of said dispenser causing a clicking sound as said tray is pulled forward or retracted back into said dispenser.

3. The product dispenser claimed in claim 1 wherein the front wall of said housing is movable to allow access to an interior of said dispenser.

4. The product dispenser claimed in claim 1 wherein said front wall includes a display window for product or graphics.

5. The product dispenser claimed in claim 2 wherein said base has at least one ridge with a serrated edge and said tab engages said serrated edge and makes said clicking sound.

6. The product dispenser claimed in claim 1 having an internal wall spaced from a bottom wall to provide a slot between a bottom edge of said internal wall and said bottom wall wherein said tray slides through said slot.

7. The product dispenser claimed in claim 6 wherein said internal wall slopes toward said front wall of said housing.

8. The product dispenser claimed in claim 2 wherein said base includes transverse raised portions and said tab engages said raised portions making said clicking sound.
